(19) United States
(12) Patent Application Publication
(10) Pub. No.: US 2025/0211877 A1
(43) Pub. Date: Jun. 26, 2025

(54) IMAGE CAPTURING APPARATUS, CONTROL METHOD OF IMAGE SENSOR, AND ELECTRONIC APPARATUS

(71) Applicant: CANON KABUSHIKI KAISHA, Tokyo (JP)

(72) Inventors: KOSUKE MATSUBARA, Tokyo (JP); HIROSHI HIRANO, Kanagawa (JP); TOSHIHARU UEDA, Tokyo (JP); SHOHEI TOZAWA, Kanagawa (JP); KAZUTO JIKEI, Tokyo (JP); FUMIHITO KARAHASHI, Kanagawa (JP); DAISUKE ITO, Tokyo (JP)

(21) Appl. No.: 19/076,134

(22) Filed: Mar. 11, 2025

Related U.S. Application Data
(63) Continuation of application No. PCT/JP2023/029418, filed on Aug. 14, 2023.

(30) Foreign Application Priority Data
Sep. 30, 2022 (JP) 2022-158762

(51) Int. Cl. H04N 25/771; H04N 25/618; H04N 25/767

(52) U.S. Cl. CPC H04N 25/771; H04N 25/767; H04N 25/618

(57) ABSTRACT

An image capturing apparatus comprises: a plurality of pixels; a plurality of output lines through which signals of the pixels are output, wherein two or more output lines are arranged in each column; a plurality of signal processing units provided in a one-to-one correspondence with the output lines and controlled between states of being connected and disconnected to and from the plurality of output lines, respectively; and a control unit. Each pixel includes: a photoelectric conversion element; an FD section that converts charges transferred from the photoelectric conversion element to voltage; and an FD extension section used to increase a capacitance of the FD section and controlled between connected and disconnected states. The control unit controls the connected and disconnected states of the FD extension sections and the connected and disconnected states between the output lines and the signal processing units.

### CROSS-REFERENCE TO RELATED APPLICATIONS

This application is a Continuation of International Patent Application No. PCT/JP2023/029418, filed Aug. 14, 2023, which claims the benefit of Japanese Patent Application No. 2022-158762, filed Sep. 30, 2022, both of which are hereby incorporated by reference herein in their entirety.

### BACKGROUND OF THE INVENTION

### Field of the Invention

The present invention relates to an image capturing apparatus, a control method of an image sensor, and an electronic apparatus.

### Background Art

PTL 1 proposes an image sensor that converts the electric charges generated in photoelectric conversion elements by one exposure into voltages using floating diffusion (FD) sections having different capacitances, thereby amplifying and reading out the voltages with a plurality of different gains.

### Citation List

### Patent Literature

PTL 1 Japanese Patent Laid-Open No. 2021-22921

However, in the conventional technology disclosed in PTL 1, when pixel signals whose voltages are amplified by different gains using the FD sections having different capacitances are AD converted, the memory capacity required for storing the conversion results increases, resulting in an increase in the circuit size.

The present invention has been made in consideration of the above situation, and enables AD conversion of pixel signals whose voltages are amplified by different gains using FD sections having different capacitances, without increasing the circuit size.

### SUMMARY OF THE INVENTION

According to the present invention, provided is an image capturing apparatus comprising: a plurality of pixels arranged in a matrix; a plurality of output lines through which signals of the plurality of pixels are output, wherein two or more output lines are arranged in each column; a plurality of signal processing units provided in a one-to-one correspondence with the plurality of output lines controlled between states of being connected and disconnected to and from the plurality of output lines, respectively; and a control unit, wherein each of the plurality of pixels includes: a photoelectric conversion element; a floating diffusion (FD) section that converts charges transferred from the photoelectric conversion element to voltage; and an FD extension section that is used to increase a capacitance of the FD section and controlled between connected and disconnected states, wherein the control unit controls the connected and disconnected states of the FD extension sections and the connected and disconnected states between the plurality of output lines and the plurality of signal processing units.

Further, according to the present invention, provided is an electronic apparatus comprising: an image capturing apparatus having: a plurality of pixels arranged in a matrix; a plurality of output lines through which signals of the plurality of pixels are output, wherein two or more output lines are arranged in each column; a plurality of signal processing units provided in a one-to-one correspondence with the plurality of output lines and controlled between states of being connected and disconnected to and from the plurality of output lines, respectively; and a control unit, wherein each of the plurality of pixels includes: a photoelectric conversion element; a floating diffusion (FD) section that converts charges transferred from the photoelectric conversion element to voltage; and an FD extension section that is used to increase a capacitance of the FD section and controlled between connected and disconnected states, wherein the control unit controls the connected and disconnected states of the FD extension sections and the connected and disconnected states between the plurality of output lines and the plurality of signal processing units; and a processing unit that processes a signal output from the image capturing apparatus.

Furthermore, according to the present invention, provided is a control method of an image capturing apparatus that comprises: a plurality of pixels arranged in a matrix; a plurality of output lines through which signals of the plurality of pixels are output, wherein two or more output lines are arranged in each column; and a plurality of signal processing units provided in a one-to-one correspondence with the plurality of output lines and controlled between states of being connected and disconnected to and from the plurality of output lines, respectively, wherein each of the plurality of pixels includes: a photoelectric conversion element; a floating diffusion (FD) section that converts charges transferred from the photoelectric conversion element to voltage; and an FD extension section that is used to increase a capacitance of the FD section and controlled between connected and disconnected states, the method comprising controlling to connect different pairs of the signal processing units to the output lines depending on whether the FD extension sections are connected or not.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of an image capturing apparatus according to an embodiment of the present invention.

FIG. 2 is a block diagram illustrating a configuration of an image sensor according to the embodiment.

FIG. 3 is a circuit diagram illustrating a circuit configuration of a pixel according to the embodiment.

FIG. 4A is a circuit diagram illustrating a circuit configuration of a column signal processing unit according to the embodiment.

FIG. 4B is a circuit diagram illustrating a circuit configuration of the column signal processing unit according to the embodiment.

FIG. 5 is a timing chart illustrating a first control according to the embodiment.

FIG. 6 is a timing chart illustrating a second control according to the embodiment.

FIG. 7 is a timing chart illustrating a third control according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

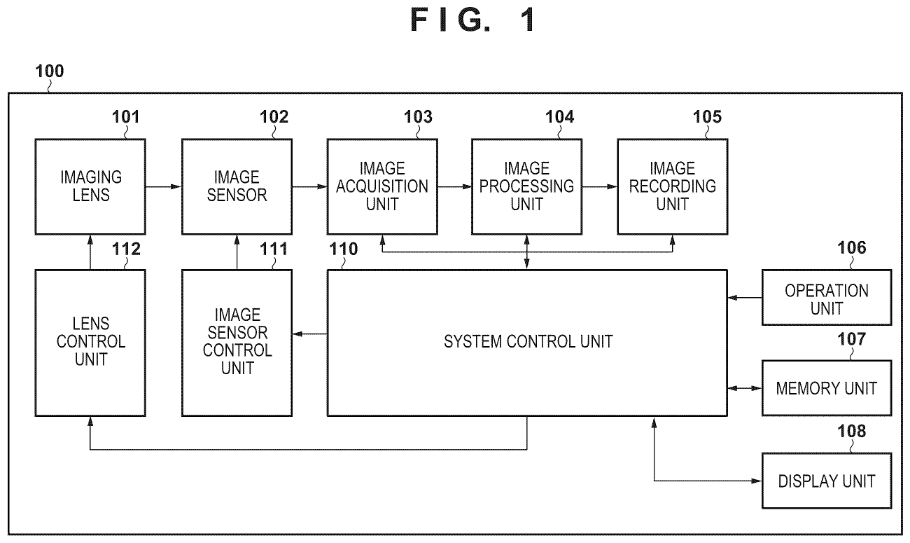

FIG. 1 is a block diagram illustrating a schematic configuration of an image capturing apparatus 100 according to an embodiment of the present invention. Note that the image capturing apparatus 100 may be any electronic apparatus equipped with a camera function, and may be, for example, a camera such as a digital camera or a digital video camera, a camera-equipped mobile phone, a camera-equipped computer, a game machine, or the like.

In FIG. 1, an imaging lens 101 is an interchangeable lens unit that can be attached to the main body of the image capturing apparatus 100, or a lens portion integrally formed on the main body, and is composed of a lens group including a plurality of lenses such as a focus lens and a zoom lens, an aperture, etc.

An image sensor 102 is composed of a CMOS image sensor, a CCD image sensor, or the like, having a plurality of pixels, and performs photoelectric conversion at each pixel on an optical image of a subject formed by the imaging lens 101 to generate electric charges according to the amount of incident light. The image sensor 102 can be actuated by at least two actuation methods. One is an actuation method in which a single gain is applied to a voltage signal corresponding to electric charges generated at each pixel in one exposure, and one image signal is output. The other is an actuation method in which a plurality of different gains are applied to a voltage signal corresponding to electric charges generated at each pixel in one exposure, and a plurality of image signals are output.

The image sensor 102 also has an electronic shutter function, including a rolling shutter function, that adjusts the amount of light to be incident on each pixel, and is capable of controlling the exposure period of the image of the subject.

An image acquisition unit 103 acquires the image signal output from the image sensor 102, temporarily stores the acquired image signal, and performs photometry using the acquired image signal.

An image processing unit 104 performs various signal processing such as noise reduction, gamma processing, color signal processing, and exposure correction on the image signal held in the image acquisition unit 103, and outputs the processed image signal.

The image processing unit 104 also generates a high dynamic range (HDR) image using an arbitrary synthesis method. For example, there is a synthesis method in which an image signal amplified with a high gain (amplification rate) is used for image portions below a certain signal level, and an image signal amplified with a low gain (amplification rate) is used for image portions above a certain signal level (bright, blown-out parts). It is preferable that random noise in dark areas is suppressed in the synthesized image.

An image recording unit 105 records the image signal processed by the image processing unit 104 in a storage device or storage medium. As the storage device or storage medium, for example, a memory device that can be attached to the image capturing apparatus 100 may be used.

An operation unit 106 includes operation members such as a release button, a mode switching dial, and a zoom operation lever, as well as a touch panel, and the like, and a user can input various instructions to the image capturing apparatus 100 by operating the operation unit 106. User inputs via the operation unit 106 are notified to a system control unit 110.

A memory unit 107 is to store instructions given by a user to the image capturing apparatus 100, and is composed of an electrically erasable and recordable non-volatile memory.

A display unit 108 is used to display shot images, information at the time of shooting, and a user interface for operation by the operation unit 106, and is composed of, for example, a TFT-LCD. Furthermore, by providing a touch panel on the front surface of the display unit 108, it may be possible for the display unit 108 to constitute part of the operation unit 106.

The system control unit 110 controls an image sensor control unit 111 and a lens control unit 112 based on the image signals and photometry results held in the image acquisition unit 103, and user inputs via the operation unit 106.

The image sensor control unit 111 controls the actuation of the image sensor 102 in accordance with control signals from the system control unit 110.

The lens control unit 112 controls the actuation of the imaging lens 101 in accordance with control signals from the system control unit 110.

Next, the configuration of the image sensor 102 will be described.

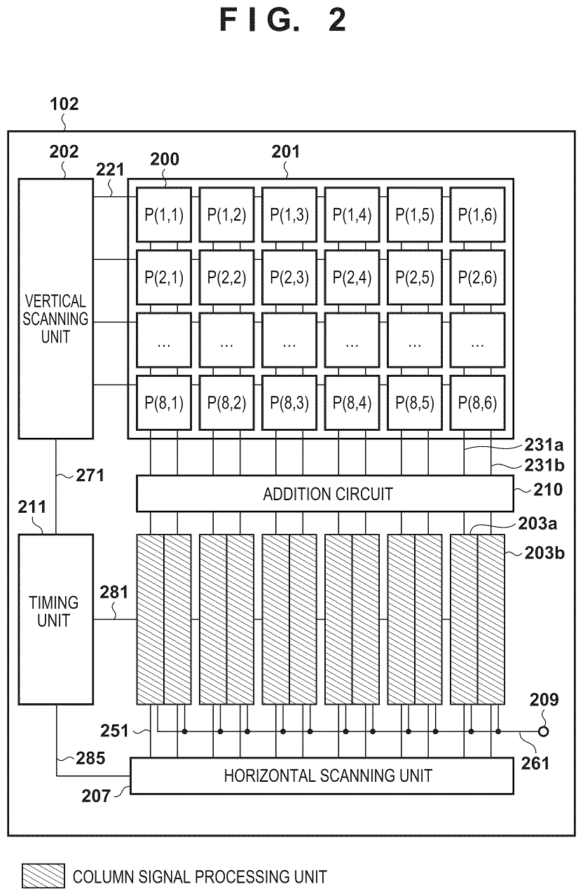

FIG. 2 is a block diagram illustrating a brief configuration of the image sensor 102 in this embodiment, and will be described here as a CMOS image sensor.

The image sensor 102 includes a pixel region 201 having a plurality of pixels 200, a vertical scanning unit 202, an addition circuit 210, column signal processing units 203a and 203b, a horizontal scanning unit 207, an output unit 209, and a timing unit 211.

The plurality of pixels 200 included in the pixel region 201 are arranged in a matrix in the horizontal (row) and vertical (column) directions.

In FIG. 2, each of the plurality of pixels 200 is expressed as “P([row number], [column number])”, such as a pixel 200 in the first row and first column being P(1,1) and a pixel 200 in the eighth row and sixth column being P(8,6). Also, although the array of pixels 200 arranged in the pixel region 201 in FIG. 2 is shown as 8 rows by 6 columns, it is typically made up of a larger number of pixels 200 than this.

The plurality of pixels 200 are arranged across the entire pixel region 201, and are covered with a Bayer color filter in which R (red) filters and G (green) filters are alternately arranged in the odd-numbered rows of pixels 200, and G (green) filters and B (blue) filters are alternately arranged in the even-numbered rows of pixels 200. In other words, the color filters are arranged to form a pattern that is repeated in units of a 2×2 array (2 rows and 2 columns).

In the pixel region 201, each pixel control line 221 is commonly connected to the pixels 200 in each row (pixel row), and each vertical signal line 231 is commonly connected to the pixels 200 in each column (pixel column). In this embodiment, as described below, it is assumed that two vertical signal lines 231a and 231b are provided for each column of the pixels 200, but the present invention is not limited thereto, and the number of vertical signal lines provided for each column may be at least two.

The vertical scanning unit 202 selects the pixels 200 in the pixel region 201 by one or two rows and controls the reset operation and readout operation of the selected pixel row or rows by transmitting actuation control signals via the pixel control line or lines 221. Each pixel control line 221 is commonly connected to the plurality of pixels 200 arranged in each row, and includes a plurality of control lines for supplying actuation control signals, such as a transfer signal pTX, an FD extension signal pFDext, a reset signal pRS, and selection signals pSEL1 and pSEL2, which will be described later.

The pixel signals of the row or rows of pixels 200 selected by the vertical scanning unit 202 via the pixel control line or lines 221 are read out to the vertical signal lines 231a and 231b connected to the respective pixels 200. The column signal processing units 203a and 203b are provided for the vertical signal lines 231a and 231b, respectively, and perform addition processing and column signal processing, which will be described later, on the pixel signals provided in units of rows supplied via the vertical signal lines 231a and 231b, and store the processed pixel signals. In this embodiment, a case will be described in which two column signal processing units 203a and 203b are provided for each column of pixels 200, similar to the vertical signal lines 231a and 231b.

The column signal processing units 203a and 203b are connected to the horizontal scanning unit 207 via column selection lines 251, respectively. The horizontal scanning unit 207 selects the column signal processing units 203a and 203b column by column via the column selection lines 251 so that digitized pixel signals stored in the the column signal processing units 203a and 203b are transferred to the output unit 209 via a horizontal output line 261.

The timing unit 211 outputs various kinds of signals such as a clock signal and control signals necessary for the operation of each part of the image sensor 102. Connected to the timing unit 211 are a signal line 271 that sends signals to the vertical scanning unit 202, a control line 281 that sends a signal to the column signal processing units 203a and 203b, and a control line 285 that sends a signal to the horizontal scanning unit 207.

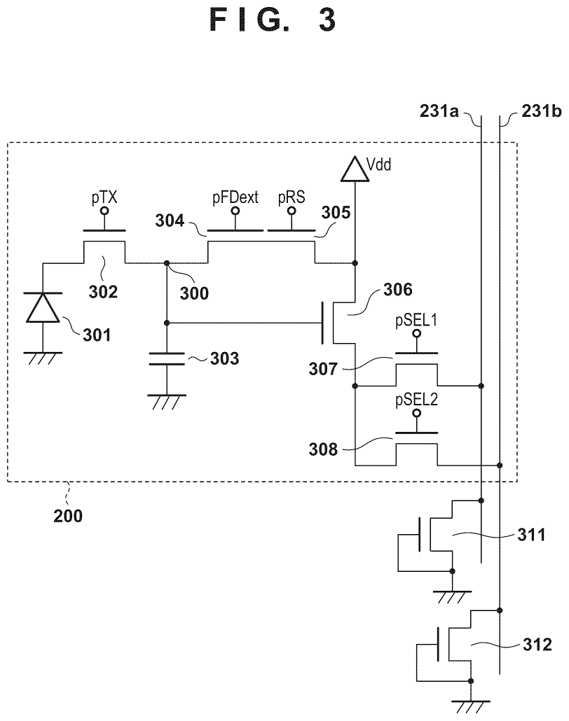

FIG. 3 is a circuit diagram showing a circuit configuration of each pixel 200 of the image sensor 102 according to the embodiment, in which one of the pixels 200 constituting the pixel region 201 is representatively shown by a rectangle of dotted line.

The pixel 200 is connected to other circuits via the pixel control line 221 and vertical signal lines 231a and 231b.

The vertical signal lines 231a and 231b are connected to a load circuit and the column signal processing units 203a and 203b, respectively, and are also connected commonly to a plurality of pixels 200 arranged in each column, transmitting pixel signals.

A photoelectric conversion element (PD) 301 is a photodiode that converts light into electric charges and accumulates the converted electric charges. The PD 301 has a p-n junction whose p-side is grounded and whose n-side is connected to the source of a transfer transistor 302.

The transfer transistor 302 has a drain connected to a floating diffusion (FD) section 303 and a gate controlled by the transfer signal pTX, thereby controlling the transfer of the electric charges from the PD 301 to the FD section 303.

The FD section 303 has one side grounded, and accumulates electric charges when converting the electric charges transferred from the PD 301 into a voltage. Hereinafter, the connecting point between the drain of the transfer transistor 302 and the other side (non-grounded side) of the FD section 303 is referred to as an FD node 300.

An FD extension transistor 304 is a MOS transistor whose gate is controlled by the FD extension signal pFDext, whose source is connected to the FD section 303, and whose drain is connected to a reset transistor 305.

The reset transistor 305 has a gate controlled by the reset signal pRS, whose drain is connected to a power supply voltage Vdd, and whose source is connected to the FD extension transistor 304.

By controlling both the FD extension transistor 304 and the reset transistor 305 to an ON state, the potential of the FD node 300 is reset to the power supply voltage Vdd. On the other hand, when both the FD extension transistor 304 and the reset transistor 305 are in an OFF state, the electric charges transferred from the PD 301 are converted into a voltage in the FD section 303.

Further, when the FD extension transistor 304 is in an ON state and the reset transistor 305 is in an OFF state, the FD extension transistor 304 functions as an accumulation section having an accumulation capacitance capable of holding electric charges. At this time, the FD extension transistor 304 and the FD section 303 are grounded in parallel to the substrate, so that the capacitance seen from the FD node 300 is the capacitance (extended capacitance) obtained by adding the capacitance of the FD extension transistor 304 to the capacitance of the FD section 303. Hereinafter, the extended capacitance is referred to as an “FD added capacitance CFDadd.” Therefore, in this case, in the FD node 300, the electric charges transferred from the PD 301 are converted into a voltage using the FD added capacitance CFDadd.

The FD added capacitance CFDadd is set so as to be able to hold the electronic charges approximately equal to the capacitance at which the PD 301 saturates, while the linearity of the charge-voltage conversion can be maintained up to the amount of the electric charges held in the FD added capacitance CFDadd. This setting state can be expressed as capacitance of PD:FD added capacitance=1:1. Also, the capacitances when expressed as a ratio of the capacitance of FD section 303 are set as capacitance of FD:capacitance of FD extension transistor:FD added capacitance: capacitance of PD=1:3:4:4.

In addition, the conversion gain of the charge-voltage conversion in the FD section 303 set as above is hereinafter expressed as a standardized value of 1 (or ×1). In this case, since the FD added capacitance CFDadd is four times the capacitance of the FD section 303, the conversion gain of the charge-voltage conversion when using the FD added capacitance CFDadd can be expressed as 1/4 (or ×1/4).

The set values of the capacitances are not limited to the above-mentioned capacitance of FD:capacitance of FD extension transistor:FD added capacitance=1:3:4, and the capacitance of the FD extension transistor 304 may be set to 1 or more. For example, capacitance of FD:capacitance of FD extension transistor:FD added capacitance=1:7:8 may be set. In this case, the conversion gain of the charge-voltage conversion in the FD added capacitance CFDadd is 1/8 (or ×1/8).

In the following explanation, charge-voltage conversion using only the FD section 303 is called “high gain conversion”, and charge-voltage conversion using the FD added capacitance CFDadd is called “low gain conversion”.

An actuation transistor 306 is a transistor that constitutes an in-pixel amplifier, and has a gate connected to the FD section 303, a drain connected to the power supply voltage Vdd, and a source connected to the drains of selection transistors (selection switches) 307 and 308.

The gates of the selection transistors 307 and 308 are controlled by the selection signals pSEL1 and pSEL2, respectively, and the sources are connected to the vertical signal lines 231a and 231b, respectively. When the selection transistor 307 is in an ON state, the pixel 200 is connected to the vertical signal line 231a, and when it is in an OFF state, the pixel 200 is disconnected from the vertical signal line 231a. Further, when the selection transistor 308 is in an ON state, the pixel 200 is connected to the vertical signal line 231b, and when it is in an OFF state, the pixel 200 is disconnected from the vertical signal line 231b. As a result, the selection transistors 307 and 308 output a voltage corresponding to the voltage of the FD node 300 via the actuation transistor 306 to the vertical signal lines 231a and 231b as output signals (reset release signal or pixel signal) of the pixel 200.

Load transistors 311 and 312 of load circuits provided on the vertical signal lines 231a and 231b respectively have their gates and sources grounded and their drains connected to the vertical signal lines 231a and 231b, respectively. The load transistors 311 and 312, together with the actuation transistor 306 of the pixel 200 in the column connected to the vertical signal lines 231a and 231b, form a source follower circuits that function as in-pixel amplifiers. Usually, when a signal from the pixel 200 is output, the load transistors 311 and 312 are operated as constant current sources with their gates grounded.

In this embodiment, transistors other than the actuation transistor 306 and load transistors 311 and 312 act as switches, and are conductive (ON state) when control lines connected to the gates are High (hereinafter referred to as “H”), and are not conductive (OFF state) when the control lines are Low (hereinafter referred to as “L”).

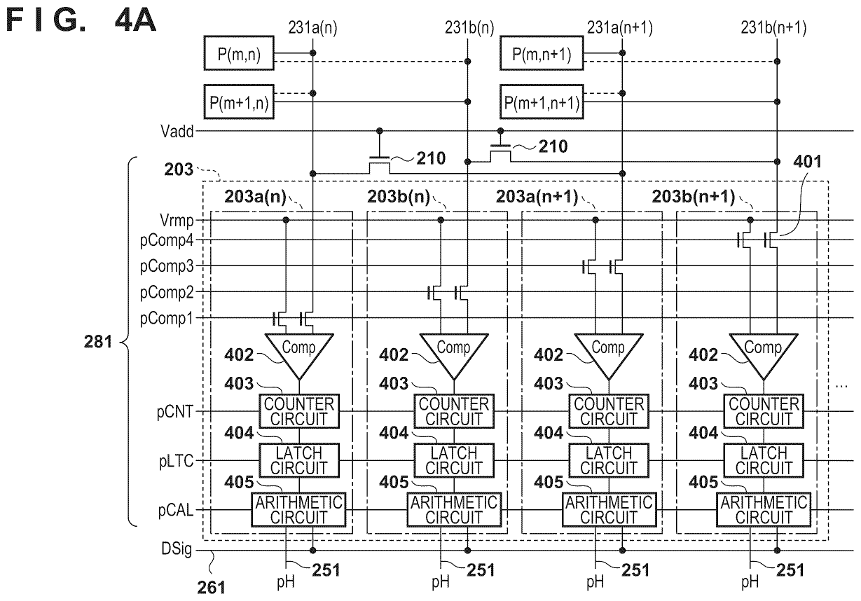

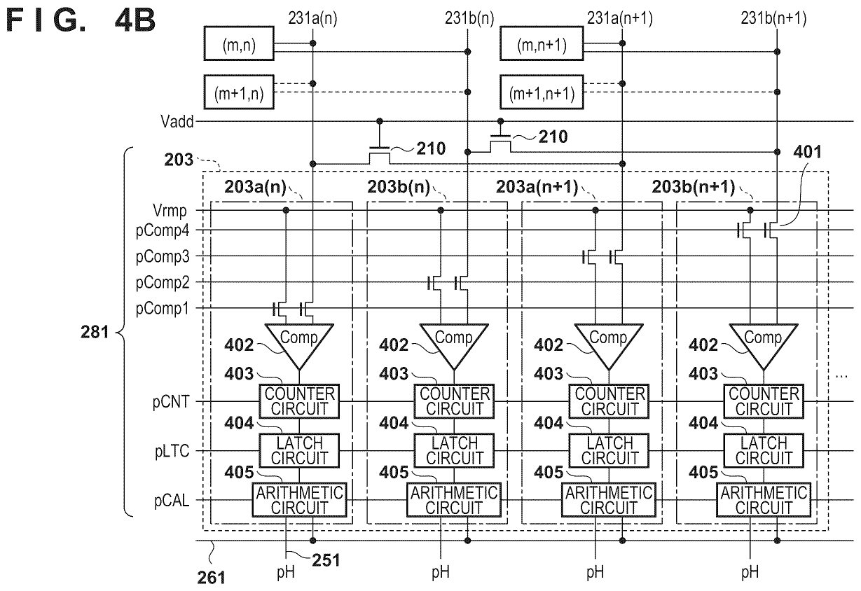

FIGS. 4A and 4B are circuit diagrams illustrating circuit configurations of the column signal processing units 203a and 203b of the image sensor 102 according to the embodiment of the present invention.

FIG. 4A shows a configuration in which two different rows of pixels 200 are connected to the two vertical signal lines 231a and 231b provided for each pixel column, and signals of the pixels 200 in the two rows are read out simultaneously. On the other hand, FIG. 4B shows a configuration in which the same pixel 200 is connected to the two vertical signal lines 231a and 231b provided in each pixel column, and signals of the pixels 200 in one row are read out at a time. The components of FIGS. 4A and 4B are the same, but the connections between the pixels 200 and the vertical signal lines 231a and 231b by the selection transistors 307 and 308 are different.

In the following description, when it is necessary to distinguish between columns, the column numbers n and (n+1) are written after the reference numerals of the vertical signal lines 231a and 231b.

Similarly, the two column signal processing units 203a and 203b are provided for each column of pixels, and therefore, when it is necessary to distinguish between them in the following description, the column numbers n and (n+1) are written after the reference numerals of the column signal processing units 203a and 203b. Each of the column signal processing units 203a and 203b includes a comparator 402, a counter circuit 403, a latch circuit 404, and an arithmetic circuit 405. As will be described below, the column signal processing units 203a and 203b function as AD conversion circuits.

The addition circuit 210 is a circuit that, when it is ON, adds pixel signals output to the vertical signal lines 231 of horizontally adjacent columns.

The comparator 402 is a circuit that outputs the comparison result of two input signals, and changes its output signal from High to Low if, for example, the magnitude relationship between the two input signals is reversed. A vertical signal line 231a or 231b and a ramp signal line that outputs a ramp signal Vrmp are connected to the comparator 402 as two input signals via connection switches 401. The connection switches 401 are controlled to be turned ON/OFF (connected/disconnected) by control signals pComp1 to pComp4, and the comparators 402 each compares the input signals when the connection switches 401 are ON.

The ramp signal Vrmp output from the timing unit 211 to the ramp signal line is a triangular wave that gradually changes from an initial voltage. It is preferable that the amplitude of the ramp signal Vrmp has a sufficient margin relative to the saturation amplitude of the pixel signal that can be input to the comparator 402. The comparator 402 outputs a comparison result at the point when the gradually changing ramp signal Vrmp crosses the signal on the vertical signal line 231a or 231b.

The counter circuit 403 operates the counter based on a clock signal pCNT supplied from a connected counter control line. The counter circuit 403 starts counting in synchronization with the start of the ramp signal Vrmp, and outputs a count value at the time of receiving a comparison result signal from the comparator 402. The output count values (discrete value) correspond to digitized signals of the pixel signals, received via the vertical signal lines 231a and 231b, by the column signal processing units 203a and 203b.

The latch circuit 404 temporarily holds the count value output from the counter circuit 403, and outputs the held count value in response to a control signal pLTC provided via a connected latch control line.

The arithmetic circuit 405 stores the count value output from the latch circuit 404 as a digital pixel signal in response to a control signal pCAL provided via a connected calculation control line, and outputs the stored digital pixel signal to a digital output line DSig in response to a control signal pH provided via a corresponding column selection line 251.

As described above, each of the column signal processing units 203a and 203b configures an AD conversion circuit using the comparator 402, the counter circuit 403, the latch circuit 404, and a ramp signal line.

Further, as described above, the control line 281 connecting between the timing unit 211 in FIG. 2 and the column signal processing units 203a and 203b includes the ramp signal line, counter control line, latch control line, and calculation control line in FIGS. 4A and 4B.

### First Control (Non-Addition, One Type of Gain, Simultaneous Two-Row Readout)

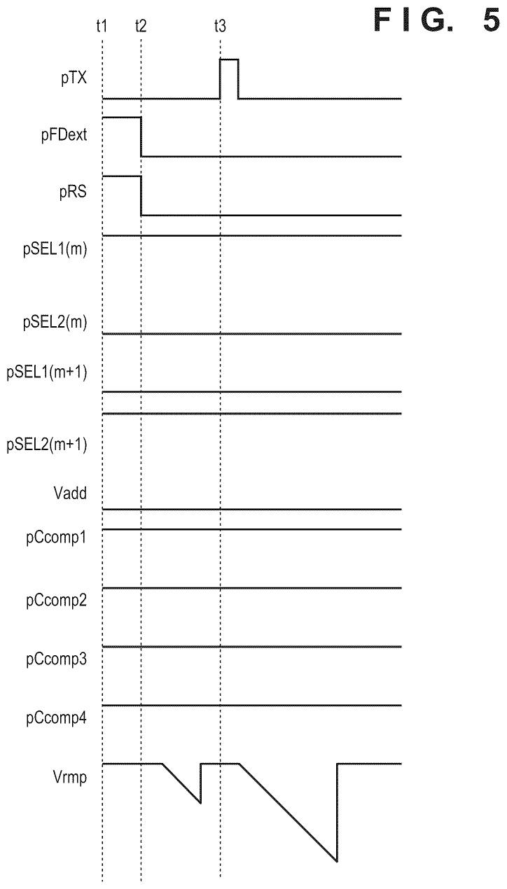

Next, a first control will be described with reference to FIGS. 4A and 5. In the first control, the addition circuits 210 are turned OFF so as not to add pixel signals between columns, and the signals of two rows amplified with one of the gains of high gain conversion and low gain conversion are AD converted simultaneously.

First, at timing t1, the selection transistors 307 and 308 in FIG. 3 are controlled by, for the m-th row, setting the selection signal pSEL1(m) to H and the selection signal pSEL2(m) to L, and for the (m+1)-th row, setting the selection signal pSEL1(m+1) to L and the selection signal pSEL2(m+1) to H. As a result, a pixel P(m,n) is connected to the vertical signal line 231a(n), and a pixel P(m+1,n) is connected to the vertical signal line 231b(n). Further, a pixel P(m,n+1) is connected to the vertical signal line 231a(n+1), and a pixel P(m+1,n+1) is connected to the vertical signal line 231b(n+1).

Moreover, the control signals pComp1 to pComp4 are set to H, and the comparators 402 of the column signal processing units 203a and 203b are connected to the vertical signal lines 231a and 231b, respectively, and the ramp signal line.

In this state, the FD extension signal pFDext and the reset signal pRS in the m-th row and the (m+1)-th row are set to H to control both the FD extension transistor 304 and the reset transistor 305 to the ON state, thereby the potential of the FD node 300 is reset to the power supply voltage Vdd. After that, at timing t2, the FD extension signal pFDext and the reset signal pRS are set to L, and the ramp signal Vramp is changed in this state, whereby AD conversion is performed in each of the column signal processing units 203a and 203b, and the count value (cn) is stored in each arithmetic circuit 405 as a reset release signal.

Next, at timing t3, the transfer signal pTX is set to H to turn on the transfer transistor 302, and charges are transferred from the PD 301 to the FD section 303. Thereafter, the ramp signal Vramp is changed to perform AD conversion in each of the column signal processing units 203a and 203b, and the count value (cs) is stored in each arithmetic circuit 405 as a pixel signal.

Then, the arithmetic circuit 405 subtracts the count value (cn) of the reset release signal from the count value (cs) of the pixel signal to obtain an image signal.

As described above, the two vertical signal lines 231 in each pixel column make it possible to simultaneously read out pixel signals from two rows.

When the reset release signal and the pixel signal are AD converted in each of the column signal processing units 203a and 203b, the FD extension transistor 304 is set to the OFF state. This allows high gain conversion to be performed, but low gain conversion may be performed by setting the FD extension transistor 304 to the ON state according to the gain setting at the time of shooting.

### Second Control (Non-Addition, Two Types of Gain, One Row Readout)

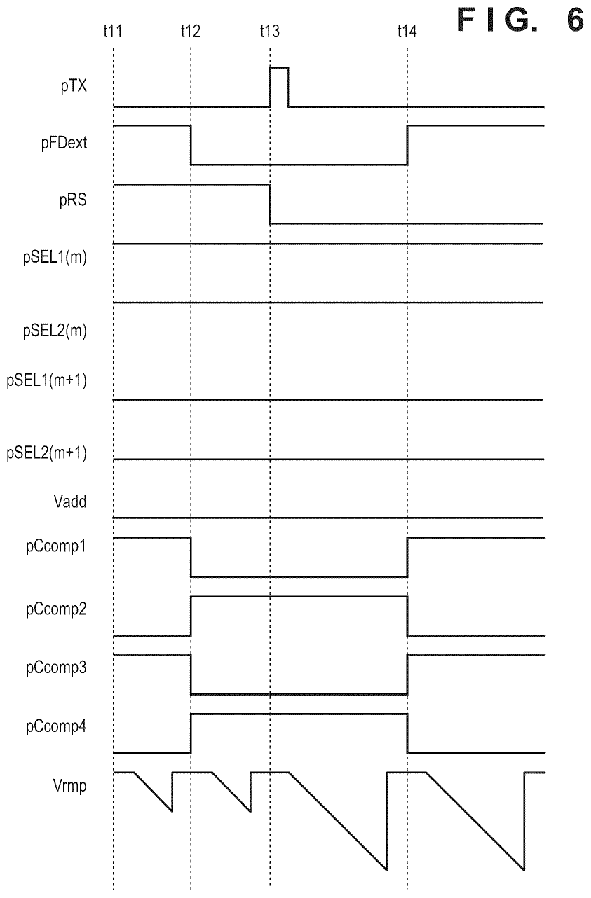

Next, a second control will be described with reference to FIGS. 4B and 6. In the second control, the addition circuit 210 is turned OFF so that pixel signals are not added between columns, and the signals of one row which are obtained through the high gain conversion and the low gain conversion are AD converted in parallel.

First, at timing t11, the selection signals pSEL1(m) and pSEL2(m) for the m-th row are set to H, and the selection signals pSEL1(m+1) and pSEL2(m+1) for the (m+1)-th row are set to L to control the selection transistors 307 and 308 in FIG. 3. As a result, a pixel P(m,n) is connected to both the vertical signal line 231a(n) and vertical signal line 231b(n). Furthermore, a pixel P(m,n+1) is connected to both the vertical signal line 231a(n+1) and vertical signal line 231b(n+1).

Moreover, the control signals pComp1 and pComp3 are set to H, and the control signals pComp2 and pComp4 are set to L, whereby the comparator 402 of each of the column signal processing units 203a(n) and 203a(n+1) is connected to the vertical signal line 231a and the ramp signal line. Furthermore, the FD extension signal pFDext and the reset signal pRS are set to H to control both the FD extension transistor 304 and the reset transistor 305 to the ON state, thereby the potential of the FD node 300 is reset to the power supply voltage Vdd. In this state, the ramp signal Vramp is changed to perform AD conversion in each of the column signal processing units 203a(n) and 203a(n+1), and the count value (low gain reset value cn−1) of the reset release signal obtained through the low gain conversion is stored in the arithmetic circuit 405.

Next, at timing t12, the control signals pComp1 and pComp3 are set to L, and the control signals pComp2 and pComp4 are set to H, whereby the comparator 402 of each of the column signal processing units 203b(n) and 203b(n+1) is connected to the vertical signal line 231b and the ramp signal line. In addition, the FD extension signal pFDext is set to L to set the FD extension transistor 304 to the OFF state. In this state, the ramp signal Vramp is changed, and AD conversion is performed by each of the column signal processing units 203b(n) and 203b(n+1), and the count value (high gain reset value cn−h) of the reset release signal obtained through the high gain conversion is stored in the arithmetic circuit 405.

Next, at timing t13, the control signals pComp1 and pComp3 are set to L, and the control signals pComp2 and pComp4 are set to H, whereby the comparator 402 of each of the column signal processing unit 203b(n) and 203b(n+1) is connected to the vertical signal line 231b and the ramp signal line. Then, the reset signal pRS is set to L to set the reset transistor 305 to the OFF state, and the transfer signal pTX is set to H to set the transfer transistor 302 to ON, whereby charges are transferred from the PD 301 to the FD section 303. After that, the ramp signal Vramp is changed, and AD conversion is performed in each of the column signal processing units 203b(n) and 203b(n+1), and the count value (high gain pixel value cs−h) of the pixel signal obtained through the high gain conversion is stored in the arithmetic circuit 405.

Furthermore, at timing t14, the control signals pComp1 and pComp3 are set to H, and the control signals pComp2 and pComp4 are set to L, whereby the comparator 402 of each of the column signal processing unit 203a(n) and 203a(n+1) is connected to the vertical signal line 231a and the ramp signal line. Then, the FD extension signal pFDext is set to H, and the FD extension transistor 304 is turned ON again. In this state, the ramp signal Vramp is changed, thereby AD conversion is performed in each of the column signal processing units 203a(n) and 203a(n+1), and the count value (low gain pixel value cs−1) of the pixel signal obtained through the low gain conversion is stored in the arithmetic circuit 405.

By the above control, the arithmetic circuit 405 of the column signal processing unit 203a of each column stores two count values cn−1 of the reset release signal obtained through the low gain conversion and cs−1 of the pixel signal obtained through the low gain conversion. Also, the arithmetic circuit 405 of the column signal processing unit 203b of each column stores two count values cn−h of the reset release signal obtained through the high gain conversion and cs−h of the pixel signal obtained through the high gain conversion.

If the AD conversion is performed for both signals obtained through the high gain conversion and through the low gain conversion signals in the same column signal processing units 203a and 203b, the number of count values to be stored in the arithmetic circuit 405 will be four, which will increase the circuit size.

In contrast, in this embodiment, the AD conversion is performed for signals obtained through the high gain conversion and signals obtained through the low gain conversion using the column signal processing unit 203a and the column signal processing unit 203b, respectively, it is possible to reduce the number of count values to be stored in each arithmetic circuit 405 to two. This is the same number as that in the case of AD conversion of pixel signals converted with a single gain into voltages by an FD with a single capacitance in FIG. 4A, so that the circuit scale can be maintained.

### Third Control (Addition, Two Types of Gain, Two-Row Readout)

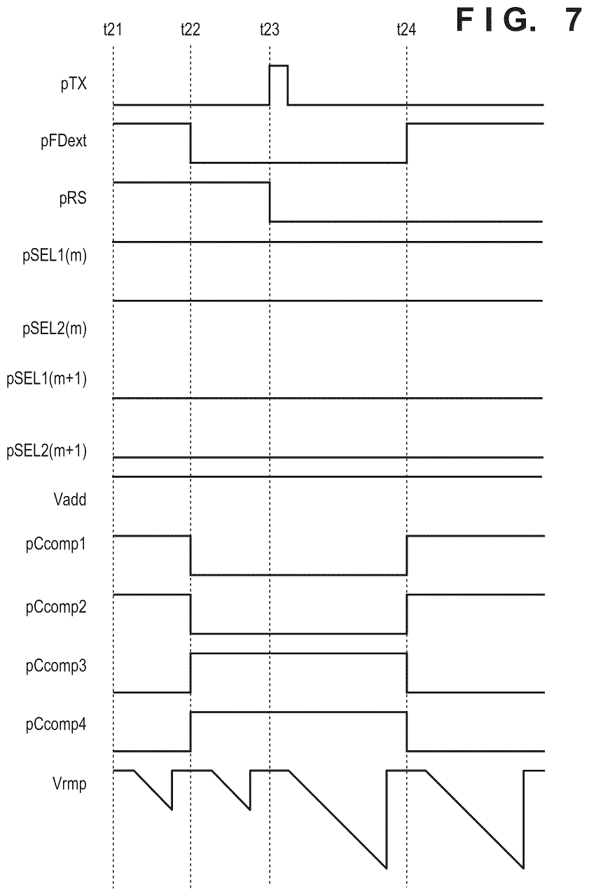

Next, a third control will be described with reference to FIGS. 4A and 7. In the third control, the addition circuit 210 is turned ON, and when pixel signals between adjacent columns are added, the two types of signals of two rows obtained through the high gain conversion and the low gain conversion are simultaneously AD-converted.

First, at timing t21, the selection transistors 307 and 308 in FIG. 3 are controlled by, for the m-th row, setting the selection signal pSEL1(m) to H and the selection signal pSEL2(m) to L, and for the (m+1)-th row, setting the selection signal pSEL1(m+1) to L and the selection signal pSEL2(m+1) to H. As a result, a pixel P(m,n) is connected to the vertical signal line 231a(n), and a pixel P(m+1,n) is connected to the vertical signal line 231b(n). Further, a pixel P(m,n+1) is connected to the vertical signal line 231a(n+1), and a pixel P(m+1,n+1) is connected to the vertical signal line 231b(n+1).

Furthermore, the addition circuits 210 are turned ON to add the pixel signal of the vertical signal line 231a(n) to the pixel signal of the vertical signal line 231a(n+1) and to add the pixel signal of the vertical signal line 231b(n) to the pixel signal of the vertical signal line 231b(n+1). As a result, the pixel signals output from the pixel P(m,n) and the pixel P(m,n+1) in the m-th row are added, and the pixel signals output from the pixel P(m+1,n) and the pixel P(m+1,n+1) in the (m+1)-th row are added.

Moreover, the control signals pComp1 and pComp2 are set to H, and the control signals pComp3 and pComp4 are set to L, whereby the comparator 402 of the column signal processing unit 203a(n) is connected to the vertical signal line 231a(n) and the ramp signal line. Further, the comparator 402 of the column signal processing unit 203b(n) is connected to the vertical signal line 231b(n) and the ramp signal line. Furthermore, the FD extension signal pFDext and the reset signal pRS are set to H to set both the FD extension transistor 304 and the reset transistor 305 to the ON state, whereby the potential of the FD node 300 is reset to the power supply voltage Vdd.

In this state, by changing the ramp signal Vramp, AD conversion is performed in the column signal processing unit 203a(n), and the count value (low gain reset value cn−1) of the added reset release signal obtained through the low gain conversion of the pixel P(m,n) and the pixel P(m,n+1) is stored in the arithmetic circuit 405. AD conversion is also performed in the column signal processing unit 203b(n), and the count value (low gain reset value cn−1) of the added reset release signal obtained through the low gain conversion of the pixel P(m+1,n) and the pixel P(m+1,n+1) is stored in the arithmetic circuit 405.

Next, at timing t22, the control signals pComp1 and pComp2 are set to L, and the control signals pComp3 and pComp4 are set to H, whereby the comparator 402 of the column signal processing unit 203a(n+1) is connected to the vertical signal line 231a(n+1) and the ramp signal line. Also, the comparator 402 of the column signal processing unit 203b(n+1) is connected to the vertical signal line 231b(n+1) and the ramp signal line. Furthermore, the FD extension signal pFDext is set to L, and the FD extension transistor 304 is set to the OFF state.

In this state, by changing the ramp signal Vramp, AD conversion is performed in the column signal processing unit 203a(n+1), and the count value (high gain reset value cn−h) of the added reset release signal obtained through the high gain conversion of the pixel P(m,n) and the pixel P(m,n+1) is stored in the arithmetic circuit 405. AD conversion is also performed in the column signal processing unit 203b(n+1), and the count value (high gain reset value cn−h) of the added reset release signal obtained through the high gain conversion of the pixel P(m+1,n) and the pixel P(m+1,n+1) is stored in the arithmetic circuit 405.

Next, at timing t23, while the control signals pComp1 and pComp2 are kept L, the control signals pComp3 and pComp4 are kept H, and the FD extension signal pFDext is kept L, the reset signal pRS is set to L to set the reset transistor 305 to an OFF state. Furthermore, the transfer signal pTX is set to H to turn the transfer transistor 302 ON, and charges are transferred from the PD 301 to the FD section 303.

Thereafter, the ramp signal Vramp is changed, and the column signal processing unit 203a(n+1) performs AD conversion on the added pixel signal of the pixels P(m,n) and P(m,n+1), and stores the count value (high gain pixel value cs−h) of the added pixel signal obtained through the high gain conversion in each arithmetic circuit 405. Similarly, the column signal processing unit 203b(n+1) performs AD conversion on the added pixel signal of the pixels P(m+1,n) and P(m+1,n+1), and stores the count value (high gain pixel value cs−h) of the added pixel signal obtained through the high gain conversion in each arithmetic circuit 405.

Furthermore, at timing t24, the control signals pComp1 and pComp2 are set to H, and the control signals pComp3 and pComp4 are set to L, whereby the comparator 402 of the column signal processing unit 203a(n) is connected to the vertical signal line 231a(n) and the ramp signal line. Also, the comparator 402 of the column signal processing unit 203b(n) is connected to the vertical signal line 231b(n) and the ramp signal line. Furthermore, the FD extension signal pFDext is set to H to turn the FD extension transistor 304 ON again.

Thereafter, the ramp signal Vramp is changed, and the column signal processing unit 203a(n) performs AD conversion on the added pixel signal of the pixels P(m,n) and P(m,n+1), and the count value (low gain pixel value cs−1) of the added pixel signal obtained through the low gain conversion is stored in the arithmetic circuit 405. Similarly, the column signal processing unit 203b(n+1) performs AD conversion on the added pixel signal of the pixels P(m+1,n) and P(m+1,n+1), and the count value (low gain pixel value cs−1) of the added pixel signal obtained through the low gain conversion is stored in the arithmetic circuit 405.

As a result, the low gain reset value cn−1 and the low gain pixel value cs−1 are stored in the arithmetic circuits 405 of the column signal processing units 203a(n) and 203b(n). Also, the high gain reset value cn−h and the high gain pixel value cs−h are stored in the arithmetic circuits 405 of the column signal processing units 203a(n+1) and 203b(n+1).

In this way, in a case where horizontal addition is performed by the addition circuit 210, high-gain and low-gain pixel signals can be processed simultaneously for two rows.

As described above, according to this embodiment, it is possible to perform AD conversion on pixel signals amplified by different gains through conversion into voltages using FDs with different capacitances, without increasing the circuit scale of the image sensor.

Note that, although the present embodiment shows addition between adjacent columns, the present invention is not limited to this and, for example, addition may be performed every other column.

Furthermore, when conversion to voltage is performed using the same FD with the same circuit configuration and addition is performed between multiple columns, it is possible to achieve faster operation.

In the above example, one FD extension transistor 304 and one reset transistor 305 are connected in each pixel, but three or more sets of a FD extension transistor and a reset switch may be connected in parallel and the ON/OFF of the plurality of FD extension transistors may be controlled. In this way, a signal can be AD converted and output using three or more gains.

### Other Embodiments

The present invention may be applied to a system made up of a plurality of devices, or to an apparatus made up of a single device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image capturing apparatus comprising:
a plurality of pixels arranged in a matrix;
a plurality of output lines through which signals of the plurality of pixels are output, wherein two or more output lines are arranged in each column;
a plurality of signal processing units provided in a one-to-one correspondence with the plurality of output lines controlled between states of being connected and disconnected to and from the plurality of output lines, respectively; and
a control unit,
wherein each of the plurality of pixels includes:
a photoelectric conversion element;
a floating diffusion (FD) section that converts charges transferred from the photoelectric conversion element to voltage; and
an FD extension section that is used to increase a capacitance of the FD section and controlled between connected and disconnected states,
wherein the control unit controls the connected and disconnected states of the FD extension sections and the connected and disconnected states between the plurality of output lines and the plurality of signal processing units.

2. The image capturing apparatus according to claim 1, wherein the control unit controls so that different pairs of the signal processing units and the output lines are connected depending on whether the FD extension sections are connected or not.

3. The image capturing apparatus according to claim 1, wherein the image capturing apparatus can be operated by a first control, and in the first control,
the control unit controls:
signals of pixels in a predetermined first row to be output to first output lines of the plurality of output lines;
signals of pixels in a predetermined second row different from the first row to be output to second output lines of the plurality of output lines; and
the plurality of signal processing units to be connected to the plurality of output lines, respectively.

4. The image capturing apparatus according to claim 1, wherein the image capturing apparatus can be operated by a second control, and in the second control,
the control unit controls:
signals of pixels in predetermined first rows to be output to first output lines and second output lines of the plurality of output lines;
to connect the FD extension sections, connect the first output lines to the corresponding signal processing units, and disconnect the second output lines from the corresponding signal processing units;
to disconnect the FD extension sections, disconnect the first output lines from the corresponding signal processing units, and connect the second output lines to the corresponding signal processing units.

5. The image capturing apparatus according to claim 1, wherein the control unit is further capable of switching between connection and disconnection between the plurality of output lines of a plurality of predetermined columns, and the image capturing apparatus can be operated by a third control, and in the third control,
the control unit controls:
to connect between the output lines of the predetermined columns;
signals of pixels in a predetermined first row to be output to first output lines of the plurality of output lines;
signals of pixels in a predetermined second row different from the first row to be output to second output lines of the plurality of output lines,
to connect the FD extension sections, connect the first output lines, connected to the first row, of the plurality of output lines to the corresponding signal processing units, and disconnect output lines connected to rows other than the first row from the corresponding signal processing units,
to disconnect the FD extension sections, connect the second output lines, connected to the second row, of the plurality of output lines to the corresponding signal processing units, and disconnect output lines connected to rows other than the second rows from the corresponding signal processing units.

6. The image capturing apparatus according to claim 1, wherein
each of the pixels includes a plurality of selection switches for switching between connection and disconnection of the FD section and to the plurality of output lines, respectively,
each of the signal processing units includes a connection switch for switching between connection and disconnection to the corresponding output line, and
the control unit switches between connection and disconnection by controlling on and off of the selection switches and the connection switches.

7. An electronic apparatus comprising:
an image capturing apparatus having:
a plurality of pixels arranged in a matrix;
a plurality of output lines through which signals of the plurality of pixels are output, wherein two or more output lines are arranged in each column;
a plurality of signal processing units provided in a one-to-one correspondence with the plurality of output lines and controlled between states of being connected and disconnected to and from the plurality of output lines, respectively; and
a control unit,
wherein each of the plurality of pixels includes:
a photoelectric conversion element;
a floating diffusion (FD) section that converts charges transferred from the photoelectric conversion element to voltage; and
an FD extension section that is used to increase a capacitance of the FD section and controlled between connected and disconnected states,
wherein the control unit controls the connected and disconnected states of the FD extension sections and the connected and disconnected states between the plurality of output lines and the plurality of signal processing units; and
a processing unit that processes a signal output from the image capturing apparatus.

8. A control method of an image capturing apparatus that comprises:
a plurality of pixels arranged in a matrix;
a plurality of output lines through which signals of the plurality of pixels are output, wherein two or more output lines are arranged in each column; and
a plurality of signal processing units provided in a one-to-one correspondence with the plurality of output lines and controlled between states of being connected and disconnected to and from the plurality of output lines, respectively,
wherein each of the plurality of pixels includes:
a photoelectric conversion element;
a floating diffusion (FD) section that converts charges transferred from the photoelectric conversion element to voltage; and
an FD extension section that is used to increase a capacitance of the FD section and controlled between connected and disconnected states,
the method comprising
controlling to connect different pairs of the signal processing units to the output lines depending on whether the FD extension sections are connected or not.
